(19) United States
(12) Patent Application Publication
(10) Pub. No.: US 2011/0258144 A1
(43) Pub. Date: Oct. 20, 2011

(54) Just 200

(75) Inventor: AHMAD CHALABI, BRIARCLIFF MANOR, NY (US)

(73) Assignee: RAFIDAIN LLC, BRIARCLIFF MANOR, NY (US)

(21) Appl. No.: 12/717,485

(22) Filed: Apr. 19, 2010

(51) Int. Cl. G06Q 90/00

(52) U.S. Cl. 705/500

(57) ABSTRACT

The Just 200 is a market capitalization weighted stock market index. It is used to track the movements of the broad US stock market. Stocks represent ownership. With ownership comes economic results and voting power. However, some companies restrict, or even remove, the voting power of some stockholders. The Just 200 is meant to be the index of choice for individuals buying stocks through an index fund because it has been designed to be the fairest to individual investors because it excludes ALL SECURITIES of companies who don't give all owners equal voting rights. The logic behind it is that every share should be entitled an equal ownership vote. Any company who doesn't adhere to that standard is curtailing the rights of individuals and should have their securities boycotted. No major stock market index uses this rule.

### OBJECTIVE

The Just 200 is a stock market index designed to be the most fair and objective measure of the broad US equity market while also being passive and transparent. We believe in equal rights for all owners—no gimmicks that shortchange investors. The index is fair since it doesn't include companies that issue “lower class” stocks. It is transparent, passive and objective in that there is a methodical system that decides components and weights.

Eligible Securities—US securities of companies incorporated in the US that give US citizens equal voting rights (common stock, REIT) and are listed on a US exchange. Float must be greater than 50% of shares outstanding. Limited Partnerships, tracking stocks and companies with more than one class of stock are ineligible since they don't give equal rights. ADRs are ineligible because the firms are not incorporated in the US.

Weighting—market cap weighted index. Weighting method:
P=Price
S=Shares Outstanding
W=Percentage Weighting
W1=P1*S1/(P1*S1+P2*S2+P3*S3 . . . P200*S200)

Rebalances—all eligible securites will be ranked at month end February, May, August and November. Any Just 200 security in the top 300 will remain in the index. Others get deleted. A deletion can occur by a reduction in market capitalization or by the security becoming ineligible. The index will be topped up to 200 by taking as many of the top ranked securities as necessary to get the number of securities to 200. This rebalance will take place around the 3^{rd} Friday of the following month (represented as Day X) in the following manner:
40% of the adjustment takes place after the close of business on day X.
15% of the adjustment takes place after the close of business on the day before day X, i.e. Day X-1.
15% takes place after the close of business on X−2.
15% takes place after the close of business on X+1.
15% takes place after the close of business on X+2.

The reason for the staggered rebalance is to reduce the gaming of index adjustments, which makes indexing more fair to indexers.

Corporate actions—Between rebalances, the index is intended to be passive. So, stock splits, stock dividends and spinoffs are included in the index as they occur. A company that gets bought for cash doesn't get replaced until the next quarterly rebalance. A company that gets bought for securities will have those securities in the index until they get evaluated the next quarter.

Benefits of the Just 200—Since the Just 200 adheres to objective rules, it avoids the perils of subjective or “managed” indices such as the S&P 500 and Dow Jones Industrial Average that are subject to the whims and emotions of its trustees or directors. The Just 200 pressures companies to be fair to their investors by ensuring all stock investors get votes, rather than capitalize on the “rational apathy” investors have when they feel their votes are meaningless or worthless. After all, stock is ownership and ownership deserves a voice. Any company that doesn't respect that shareholder right is excluded. The Just 200 counts blocks that float-weighted indices may not count because that is what's fair—a share is a share and no shares should be discriminated against (a share is a share and should always count). Rebalances are handled over a five day period to lessen their impacts (and to lessen the effect of frontrunners who hurt the average indexer). Component companies must be incorporated in the US to avoid the potential unfairness of preferential tax treatment foreign based corporations may receive. 200 stocks are chosen because approximately 65% of the weight of all eligible securities are covered, making it both diverse and efficient.

Index Components (in approximate order of weighting) as of Dec. 18, 2009—XOM, MSFT, WMT, AAPL, PG, JNJ, GE, IBM, JPM, PFE, T, CVX, WFC, CSCO, BAC, KO, ORCL, MRK, HPQ, INTC, PEP, C, PM, VZ, ABT, GS, QCOM, SLB, COP, MCD, UTX, OXY, MMM, AMGN, MDT, USB, HD, AXP, CVS, BA, GILD, BLK, MON, KFT, LLY, BMY, MO, CL, TGT, UNH, MS, WAG, EMC, BK, BAX, APA, CAT, LOW, DOW, UNP, APC, EMR, TWX, EBAY, DVN, HON, FCX, EXC, MHS, MET, GLW, DD, WLP, TXN, LMT, TRI, HAL, CELG, TRV, DELL, XTO, SO, GD, MOS, COST, FDX, PNC, KMB, PCU, PRU, DHR, BEN, GIS, PX, ESRX, EOG, AFL, D, YHOO, SCHW, DE, ITW, STT, DUK, NEM, MRO, SYK, K, ADP, SPG, FPL, RTN, CME, JCI, BBT, HES, ADM, TMO, NSC, BDX, NOV, AGN, CSX, NOC, AMAT, AIG, ADBE, CB, SPLS, MOT, AEP, CHK, APD, SBUX, COF, SYY, YUM, ALL, TJX, PCG, WM, MCK, RAI, L, PEG, BUB, KSS, BBY, SWN, TWC, SYMC, PCP, ETR, BHI, GENZ, SE, KR, HNZ, TROW, BSX, FE, NUE, AVP, GPS, DO, AET, JNPR, ATVI, PCAR, NBL, AA, ISRG, WMB, ZMH, WU, NTRS, STJ, SRE, ED, STI, BTU, LO, CA, VNO, MMC, PGR, CAH, CPB, PPL, MHP, OMC, COH, CCI, EIX, PGN, AON, LVS, AMID, PAYX, ECL.

Notable ineligible securities—ACS, AMT, APH, APDL, BF, BRCM, BRK, CBS, CMCSK, CTSH, DISCA, DISH, DLB, F, GOOG, H, LBTYA, MA, MAR, MKC, NKE, NWS, PSA, SNI, TAP, TSN, UPS, V, VIA, VMW, VRSK.

1. The Just 200 is unique in that it is the only index that by rule excludes every class of stock issued by companies with multiple classes of stock. Most other broad market indices include one class or more, if the securities would otherwise be eligible for inclusion.
